(19) United States
(12) Patent Application Publication
(10) Pub. No.: US 2020/0267146 A1
(43) Pub. Date: Aug. 20, 2020

(54) NETWORK ANALYTICS FOR NETWORK SECURITY ENFORCEMENT

(71) Applicant: HEWLETT PACKARD ENTERPRISE DEVELOPMENT LP, Houston, TX (US)

(72) Inventors: Brijesh Nambiar, Santa Clara, CA (US); Manisha Singh, Santa Clara, CA (US)

(21) Appl. No.: 16/278,517

(22) Filed: Feb. 18, 2019

(51) Int. Cl. H04L 29/06; G06N 20/00

(52) U.S. Cl. CPC H04L 63/0876; H04L 63/1433; G06N 20/00; H04L 63/083; H04L 63/0263; H04L 63/0236; H04L 63/1416

(57) ABSTRACT

An integrated network security enforcement system is provided. Information from a network access control (NAC) device, network analytics engine (NAE) executing on a network analytics server (NAS), and a network controller are used to control network access of a client device and associated user. A login session for the user may be monitored by the NAE. Events based on risk analysis of user-initiated actions are sent to the NAC device and/or the network controller. Events may indicate to take action with respect to the client device (or user). For example, user-initiated actions that cumulatively appear as a security threat on a device (and possibly other devices) may be isolated or forced to re-authenticate. Risk assessment may be reduced if higher levels of authentication are performed by the user. Two-factor, or biometric authentication may allow greater risk (e.g., reduced risk assessment) than a login session using a single password.

### BACKGROUND

Networks of computers that support business activities are often composed of a multitude of infrastructure devices (e.g., computational, storage, and network resources). These infrastructure devices may provide, for example, a cohesive system of coordinated computing devices that support many automated functions for a corporate enterprise. In some cases, these computing devices are connected to a network for communication with each other. Wireless and wired networks may be connected to each other, for example, using a device referred to as an access point (AP). Some devices connected to a network as infrastructure devices may perform network monitoring and security checks on network activities. These infrastructure devices may include, but are not limited to, firewalls, network data analyzers (sniffers), network analytics servers, network performance monitors, and access control servers. These and other types of network infrastructure devices may provide data or event information to security or performance monitoring network components.

Client devices (both wired and wireless) may perform network operations in their normal course of operation. Different types of network operations may pose different types of security and performance constraints on a system. For example, a user may inadvertently initiate a global search across a large amount of storage during a peak working hour. This unintended performance impact on one or more servers may represent an undesired condition for a corporate enterprise. In addition to inadvertent actions, some actions may be initiated that may pose an actual (or perceived) security risk to an organization.

### BRIEF DESCRIPTION OF THE DRAWINGS

The present disclosure may be better understood from the following detailed description when read with the accompanying Figures. It is emphasized that, in accordance with standard practice in the industry, various features are not drawn to scale. In fact, the dimensions or locations of functional attributes may be relocated or combined based on design, security, performance, or other factors known in the art of computer systems. Further, order of processing may be altered for some functions, both internally and with respect to each other. That is, some functions may not perform serial processing and therefore those functions may be performed in an order different than shown or possibly in parallel with each other. For a detailed description of various examples, reference will now be made to the accompanying drawings, in which:

FIG. 1 is a functional block diagram representing an example of data and event control flow between a network access control (NAC) device, a network analytics server, and a network controller communicatively coupled to a client device, according to one or more disclosed examples;

FIG. 2 is a functional block diagram representing example data source feeds for a network analytics engine and possible functional modules (e.g., subroutines, processes, applications) that may execute as part of, or on behalf of, a network analytics engine that itself executes on a network analytics server, according to one or more disclosed examples;

FIG. 3 is a functional block diagram illustrating a possible sequence of interactions between a network access control (NAC) device, a network analytics server, a client controller, and an associated client device, according to one or more disclosed examples;

FIG. 4 is a functional flow diagram representing an example method performed by a system implemented to perform integrated network security and network analytics to assist security enforcement, according to one or more disclosed examples;

FIG. 5 is an example computing device with a hardware processor and accessible machine-readable instructions that may be used to compile and execute the algorithm that provides the example method of FIG. 4, according to one or more disclosed examples;

FIG. 6 represents a computer network infrastructure that may be used to implement all, or part of the disclosed network security enforcement infrastructure augmented using a network analytics server, according to one or more disclosed implementations; and

FIG. 7 illustrates a computer processing device that may be used to implement the functions, modules, processing platforms, execution platforms, communication devices, and other methods and processes of this disclosure.

### DETAILED DESCRIPTION

Illustrative examples of the subject matter claimed below will now be disclosed. In the interest of clarity, not all features of an actual implementation are described for every example implementation in this disclosure. It will be appreciated that in the development of any such actual example, numerous implementation-specific decisions may be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Various network analytics servers exist and, at a high-level, may be thought of as providing intelligence and data analysis (static repository analysis and network traffic analysis) to add context and derive historical attributes about network data to assess risks (among other things). Variations of network access control (NAC) devices (NAC as mentioned above) exist and are provided by various vendors. In general, NAC systems provide challenge response authentication to identify users with respect to logging in, gaining access to data, or performing functions (with proper privileges) on a computer system.

Determining the potential security risk may rely on analysis performed by a network analytics engine. In some cases, a network analytics engine may factor in several different types of parameters when determining whether or not to let the action commence (or proceed if already started). The different types of parameters may include who the authenticated user initiating the action is (e.g., vice president versus janitor), the amount of risk associated with the action (e.g., level of security vulnerability based on type of access performed, or expected to be performed, by the action), and/or a type of authentication used by the user (e.g., two factor versus simple password). Based on analysis of these parameters, different determinations may be made by an analytics engine as to a degree of risk associated with the action.

In one or more implementations of this disclosure, integrated decision making and enforcement by a network analytics engine and authentication engine working together to analyze and allow execution of user-initiated actions. In one example, a network analytics server and a NAC may exchange information about each user and identify any anomalous activity. Once identified, it may be further determined to control data access or actions allowed on a dynamic basis, for example, prior to execution of the user-initiated action or based on a run-time determination while the user-initiated action is executing. Further, post execution (or post attempted user-initiation of actions) metrics may be collected pertaining to the user-initiated action. These metrics may be provided to a network analytics server for use when making a future determination about a repeat request for this same user-initiated action or other user-initiated actions that may be similar to the action originating the metric collection. Using disclosed techniques, manual intervention by network administrators (e.g., security administrators) may be elided and automated response events and actions may be provided by an enhanced network security system.

Disclosed techniques enhance overall network security by integrating and sharing information between two normally independent systems within an enterprise. For example, it is common for a customer network to have independent systems that independently provide a NAC and network analytics. NAC systems are more common as small enterprises will typically have a NAC, but network analytics may be more prevalent in larger enterprises with larger networks. In any case, these two systems, if present, are typically configured to provide each of their respective functions independently from each other.

In one example implementation, a NAC may extend its capability set (e.g., with respect to detecting malicious or abnormal activity), in part, by utilizing data provided by a network analytics engine. In some disclosed implementations, this data is proactively provided by the network analytics engine (executing on a network analytics server) to the NAC as opposed to analytical data passively being available upon request. Further, disclosed NAC implementations may proactively provide data regarding actions to a network analytics engine to enhance network analysis capabilities (e.g., real-time awareness of actions taken). The NAC may provide this information as part of performing actions to dynamically isolate any device or user. The data may be provided as events, alerts, messages, or other types of mechanisms. In one example, hypertext transport protocol (HTTP) messages may be used (e.g., provided via a representational state REST interface).

In general, disclosed implementations include a NAC as the entry point for users and devices into the computer network. That is, the NAC performs its standard function of authentication to “connect” a user (or guest) to obtain network access and therefore has the initial information about devices such as device category, hostname, device posture, and user's information including username, email address, role, login time, location etc. Additionally, disclosed implementations include a network analytics engine that provides a user and entity behavioral analytics solution that may be used to detect small changes in behavior of the users. Accordingly, behavioral analytics, as provided by the network analytics engine, may be used to predict attacks, identify compromised devices, identify negligent users, etc. Thus, the combination of these two capabilities, as provided in disclosed implementations, may reduce (or eliminate in some instances) manual intervention by an IT administrator, in part, because the network analytics/NAC combination may automatically act to isolate/quarantine any detected malicious (or abnormal) user or device. In a simple example, if a user moved to an office or location where that user is not authorized to be, network analytics would provide this information (about relocation) to a NAC that may create an alert or take other action.

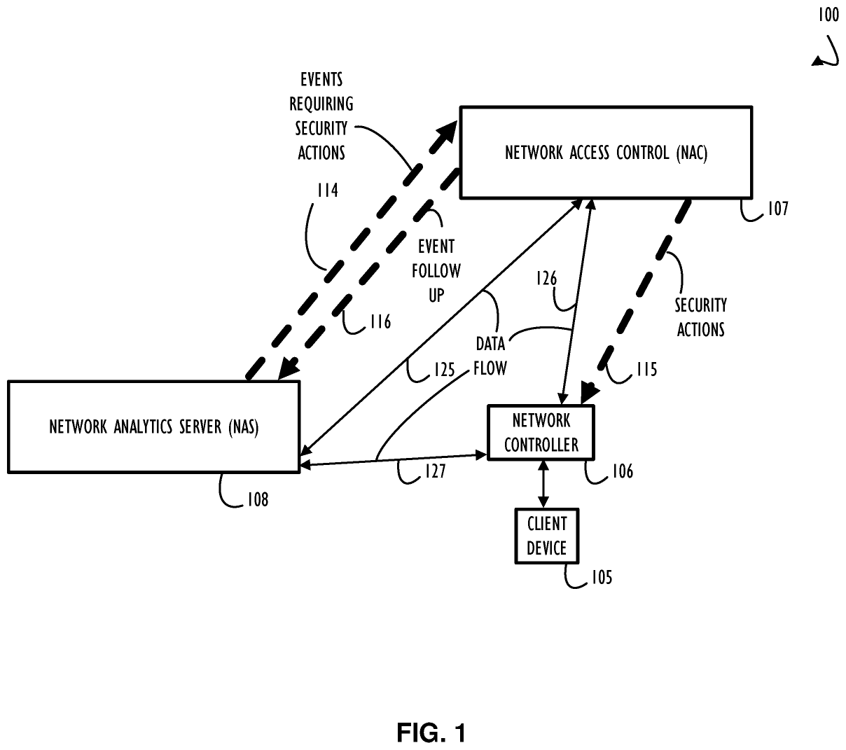

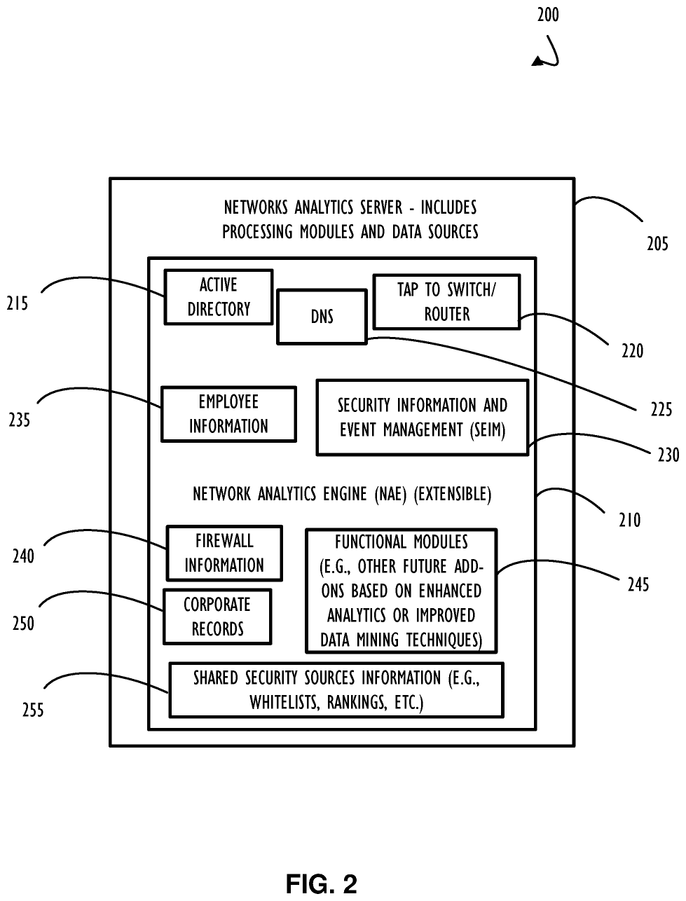

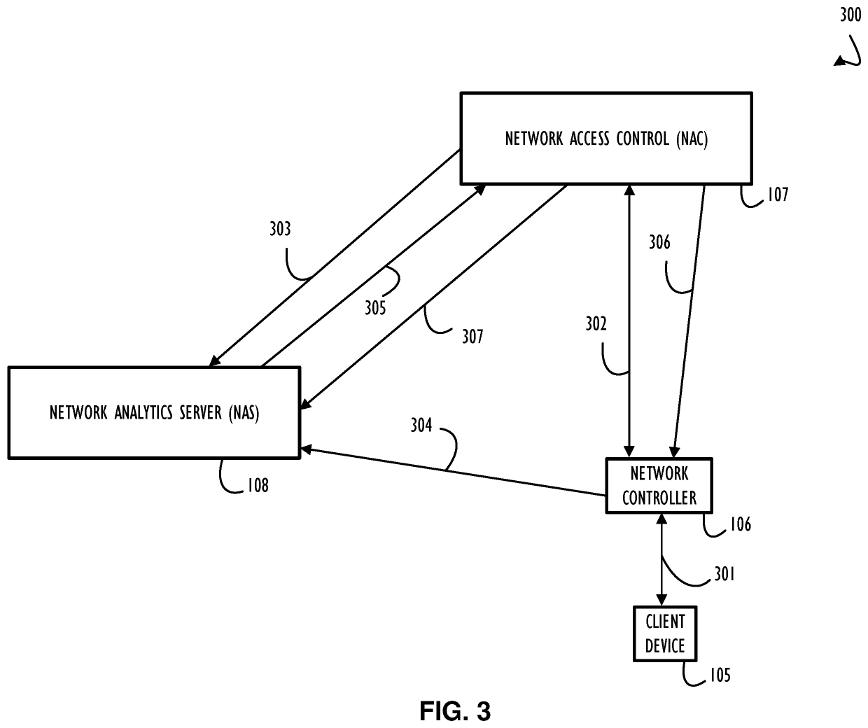

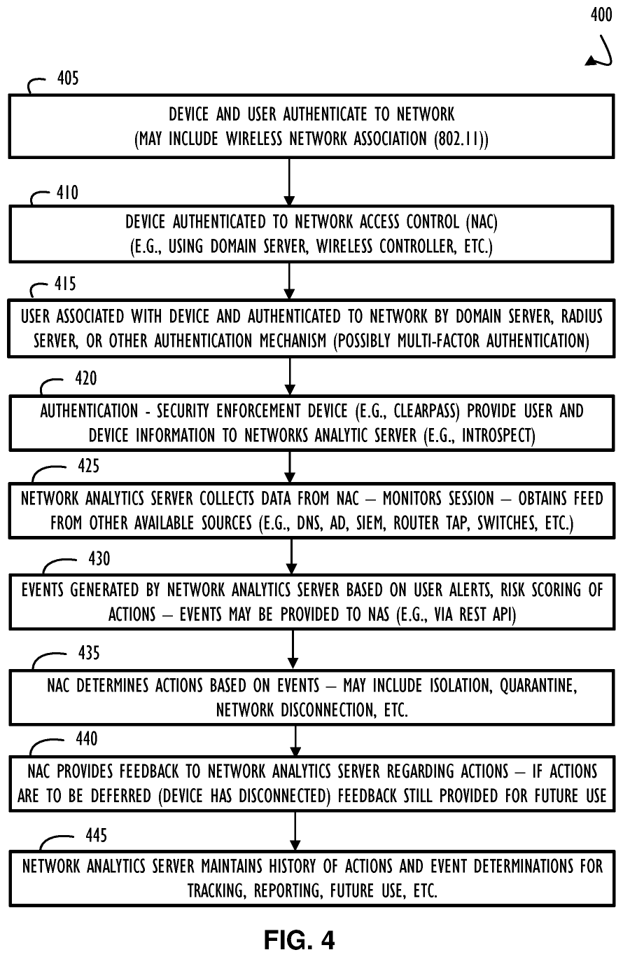

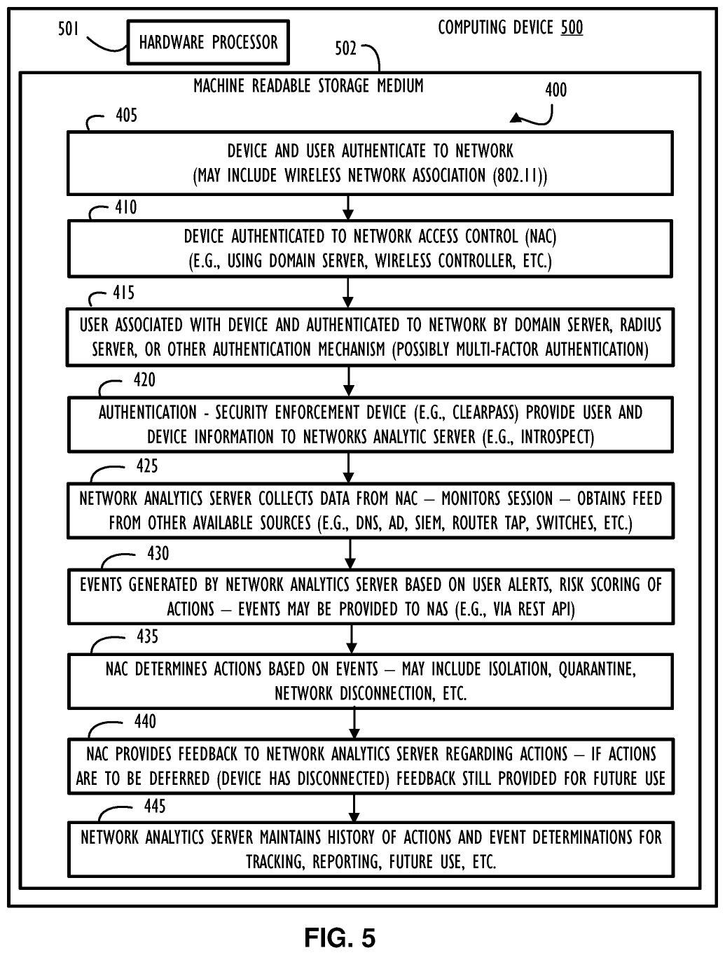

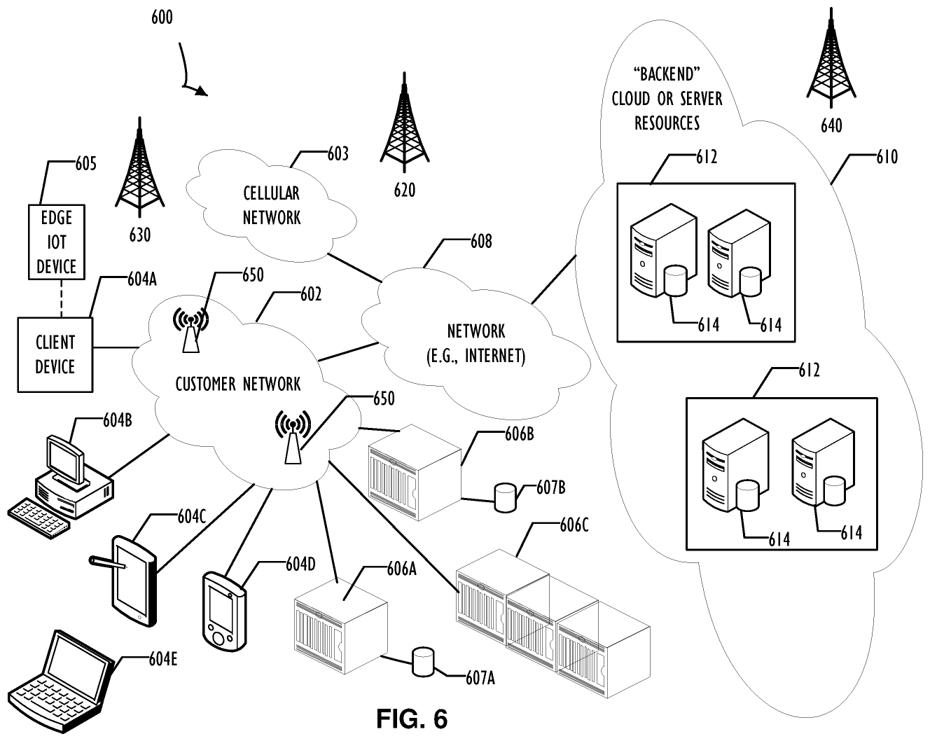

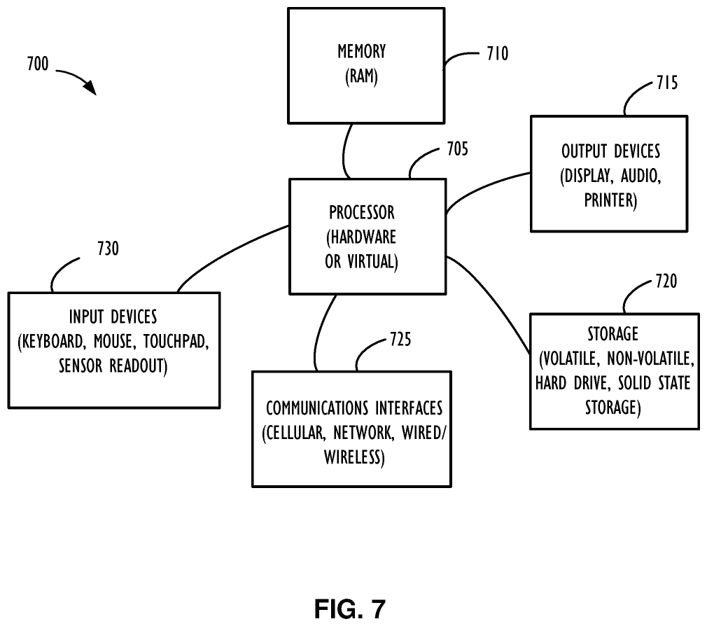

Having an understanding of the above overview, this disclosure now explains a non-limiting example implementation (and possible variants thereof). Examples are explained with reference to the figures that include: a functional block diagram representing an example of data and event control flow between a network security server, a network analytics server, and a network controller communicatively coupled to a client device (FIG. 1); a functional block diagram representing example data source feeds for a network analytics engine and possible functional modules (e.g., subroutines, processes, applications) that may execute as part of, or on behalf of, a network analytics engine that itself executes on a network analytics server (FIG. 2); a functional block diagram illustrating a possible sequence of interactions between a NAC, a network analytics server, a client controller, and an associated client device (FIG. 3); an example method representing an example of functions of a system implemented to perform integrated network security and network analytics to assist security enforcement (FIG. 4); an example computing device with a hardware processor and accessible machine-readable instructions that may be used to compile and execute the algorithm that provides the functional flow of FIG. 4 (FIG. 5); a computer network infrastructure that may be used to implement all or part of the disclosed system utilizing network analytics as part of security enforcement (FIG. 6); and a computer processing device that may be used to implement the functions, modules, processing platforms, execution platforms, communication devices, and other methods and processes of this disclosure (FIG. 7); (all according to one or more disclosed example implementations).

As mentioned above, disclosed systems may reduce manual intervention involvement in network security enforcement using automated techniques based, in part, on machine learning and deep data analysis. Accordingly, disclosed systems and techniques represent an improvement to the art of computer system administration. For example, actions initiated on client computer systems may represent fully authenticated requests initially. Based on monitoring and analysis prior to execution or while an action is executing, further determinations may be made with respect to the actions initiated on a given device (and associated with an authenticated user). These further determinations may cause termination of the executing action, quarantine/isolation of one or more client computers, event and alert generation, and/or generation of metadata that may be used for future analysis with respect to future actions by either the device or the user associated with the device and the action. Any dynamically isolated device or user may be tracked and used for reporting purposes. For example, a timeline of events may illustrate actions taken for use in post mortem analysis of a system failure (or performance degradation).

Referring now to FIG. 1, network segment 100 represents an example of data and event control flow between a network access control device (illustrated as NAC 107), a network analytics server 108, and a network controller 106 communicatively coupled to a client device 105. Although only a single client device 105 is illustrated in FIG. 1, it should be recognized that any number of client devices may be controlled using disclosed systems and techniques. As illustrated in network segment 100, client device 105 connects to a customer network (not illustrated) via network controller 106. The initial connection between client device 105 and network controller 106 may be performed using authentication that may be performed by NAC 107. This initial connection would utilize communication flow 126 to authenticate one or both of client device 105 and a user (not shown) attempting to log in via client device 105. Authentication may be implemented in a number of ways and utilize single factor or multi-factor authentication. In single factor authentication, a simple password or personal identification number (PIN) may be supplied by a user via a user-interface of client device 105. In multi-factor authentication, more than one authentication step is used. For example, a user at user-device 105 may enter a password and receive (e.g., via their cell phone) a text message including a randomly generated number (e.g., generated by the NAC) that may be valid for a relatively short period of time. Thus, upon entry of the random number (second factor) in addition to the password (first factor), a two-factor authentication may be accomplished. Clearly, two-factor authentication is more secure than single factor authentication, in part, because both a user's password and that user's cell phone would need to be in possession to accomplish login. Another example of authentication may be biometric authentication where a physical characteristic (e.g., finger print, voice print, facial recognition, etc.) may be used as one of the factors associated with authentication. In any case, upon successful login, a type of authentication performed may be stored by NAC 107.

Continuing with FIG. 1, network segment 100 includes data flow 125 between NAC 107 and network analytics server 108. Upon successful (or failed) authentication, information may be shared from NAC 107 to network analytics server 108 (via data flow 125) to inform network analytics server 108 of failed login attempts by a user/device (e.g., user on client device 105) or that a user has been authenticated via client device 105. Additionally, one or both of NAC 107 or network analytic server 108 may provide information to network controller 106 with respect to authentication status and allowance of the user at client device 105 onto the network. If, for example, authentication was not successful, one or both of NAC 107 or network analytics server 108 may transmit information to network controller 106 to prohibit communication from client device 105 from entering the network. One possible connection between network analytics server 108 and network controller 106 is illustrated by data flow 127.

Another mechanism for network analytics server 108 to affect network controller 106 is illustrated by security actions 114 whereby network analytics server 108 may send an event (e.g., a high priority message) to NAC 107 informing NAC 107 to instruct network controller 106 (e.g., via security actions 115) to not allow further network communication from client device 105. Thus, data affecting client device 105 may not flow directly to network controller 106 from a device determining an action. In some cases, the action/information may be provided via an indirect connection and performed by an intermediary (in this example NAC 107 acts as an intermediary for network analytics server 108 based on the event follow up 116).

Completing the discussion of network segment 100, data flows 125, 126, and 127 illustrate that each of network analytics server 108, network controller 106, and NAC 107 may intermittently share information amongst each other, while, direct connections to client device 105 may be from network controller 106. In an alternative not shown, direct connections from other devices in network segment 100 to client device 105 may be possible. Event follow up 116 represents a data flow whereby messages may be sent from NAC 107 to network analytics server 108 to maintain information regarding actions taken (e.g., actions directed toward client device 105) within network analytics server 108. As mentioned above, maintaining of historical actions with respect to a device and/or user may allow a network analytics engine executing on network analytics server 108 to perform future analysis with knowledge of past actions. Note, that event traffic illustrated as bold dashed arrows may actually flow through either data flow 125 or 126 as appropriate and is not intended to indicate a separate network connection path exists, although multiple network connections may exist for any of the data or event flows illustrated.

Referring now to FIG. 2, component architecture 200 illustrates a network analytics server 205 and possible functional components and/or data sources that may be used by network analytics engine (NAE) 210 executing on network analytics server 205. As illustrated, example modules and data sources that may be used to perform network analytics by an NAE may vary in type and function. Some example data sources include an active directory 215, a tap to a switch/router 220, domain name server (DNS) 225, employee information 235, firewall information 240, corporate records 250, and shared security sources 255. Functional modules 245 may include analytics and data mining techniques (as well as other future add-ons). Security and information management (SEIM) 230 may represent a set of functionalities for NAE 210 as well as potential sources of data. In general, NAE 210 may take many inputs and perform analytical analysis of user-initiated actions based on information derived from the many sources.

Active directory 215 may represent information about users, data, and devices of a corporate network. DNS 225 represents a computer infrastructure component that assists in resolving domain names into network internet protocol (IP) addresses. Tap to switch/router 220 represents information obtained from a network infrastructure device such as a switch or a router and may be obtained by “sniffing” the network. Sniffing the network references monitoring data packets passively as they traverse the network and analyzing addressing information (and possibly content) of those data packets. Content analysis of data packets is sometimes referred to as deep packet analysis. Employee information 235 may represent password files from an operating system (possibly also available from active directory 215) or human resource database information about employees, as an example. Firewall information 240 may include whitelist information about devices, addresses, or web sites and may also include rules about permitted and blocked traffic within a corporate network. Corporate records may include information maintained by a corporation with respect to corporate policies, guidelines, etc. and may be used as an input to analytics functions performed by NAE 210. Shared security sources information 255 represents other information, potentially from other security based infrastructure devices, that may include rankings of potential security risk for certain actions or data sources within the corporate enterprise (e.g., a human resources database may have different credential requirements than a scheduling database). These types of sources are examples only to illustrate the types of data that may be used by an NAE to perform disclosed functions. Other sources of data and analysis techniques may be available as indicated within the block for functional modules 245.

Referring now to FIG. 3, a functional block diagram illustrates a functional sequence flow 300 of interactions between a network security server (e.g., a device illustrated as NAC 107), a network analytics server (e.g., NAS 108), a client controller (e.g., illustrated as network controller 106), and an associated client device 105, according to one or more disclosed examples. Functional sequence flow 300 begins with bi-directional connection 301 where a user at client device 105 (or the device itself) attempts to initiate an action. Actions are typically initiated on behalf of a user. Accordingly, the action being initiated in this example may be associated with a device/user pair. This action will first be received by network controller 106, which may share information about the user/device and requested action via connection 302 with NAC 107. Upon receipt of information about the requested action, connection 303 indicates that information may be shared between NAC 107 and network analytics server 108.

Connection 304 indicates that network analytics server 108 may monitor and receive information about the action both at initiation of the action and while said action is being performed on behalf of the user/device pair that initiated the action. In this manner, network analytics server may monitor for anomalous (or malicious) behavior within the network that may be associated with the action and user/device pair that initiated the action. Connection 305 indicates that results of analysis may be provided from network analytics server 108 to NAC 107. This information may be provided periodically while said action is executing and/or may be provided at the completion of the action. In either event, network analytics server 108 provides information that is current to NAC 107 so that NAC 107 may perform any required actions.

For example, a suspect activity may be identified and associated with the action, however, at this point there is only suspected activity. If additional suspect activity raises to a level of concern (e.g., crosses a potential threat threshold), NAC 107 may attempt to quarantine/isolate client device 105 from performing further activities associated with the action or may prevent client device 105 (via network controller 106 and connection 306) from performing any further network activities. Connection 307 indicates that, if NAC 107 requests network controller 106 to perform any security related event with respect to client device 105, network analytics server 108 maintains correct historical information about these security related events and may associate them with the user/device pair for use in future analysis. Connection 307 may also be used to inform network analytics server 108 that no security related events were required and any associated risk level with respect to the action or user/device pair may be removed (or reduced). In this manner, constant feedback may be collected and provided across integrated systems to perform elements of the disclosed network analytics for network security enforcement system.

To summarize, a device/user (e.g., client device 105) associates with a network (e.g., via a network controller 106). NAC 107 authenticates the client device 105 (and a currently associated user). NAC 107 passes information about client device 105 (and a currently associated user) to network analytics server 108. Network analytics server 108 initiates collection of data from NAC 107 and monitors a login session. Sources of data for monitoring include network controller 106, DNS 225, active directory 215, SEIM 230, tap to switch/router 220, and other sources. Based on user alerts and risk score, network analytics server 108 generates events (using system log messages or REST application program interfaces (APIs)) that are passed to NAC 107. NAC 107 acts on events as necessary and dynamically isolates/quarantines the client device 105 (or user associated with client device 105) via network controller 106. Note, a user associated with client device 105 may also be quarantined on other devices based on a security action caused by client device 105. NAC 107, periodically or based on an event, notifies network analytics server 108 about potential future remediation action for client device 105 (or associated user) with respect to future connection attempts (e.g., login attempts, or user-initiated actions). All available information may be used by network analytics server 108 for tracking and reporting purposes.

In general, a login session associated with a user and device may be monitored by the combination of NAC 107, network analytics server 108, and network controller 106. As each user-initiated action of the login session is processed, an associated risk value for the individual action may be determined. A cumulative risk value for the login session may be maintained, for example, on NAC 107. Upon crossing a risk action threshold (e.g., as determined by NAC 107 based on cumulative scoring for user-initiated actions of the login session), NAC 107 may initiate an event (e.g., to network controller 106) to perform a security action on client device 105. The security action may include forcing a re-authentication prior to proceeding with further network communications or may include an indication to network controller 106 to quarantine/isolate client device 105. Note, upon actual isolation of client device 105, NAC 107 may inform network analytics server 108 of the action taken. In turn, network analytics server 108 may alter further risk analysis determinations for other devices that may also be associated with the user of client device 105 (e.g., user that caused the security action). In this manner, if a user is determined to be conducting anomalous (or malicious) behavior on one device, that user may be quickly terminated on other devices prior to causing a potentially greater security breach. For example, if a user's password is compromised, a malicious actor may attempt to perform user-initiated actions that each have a marginal risk value across a number of client devices concurrently (e.g., in an effort to obscure their network intrusion). By having a cumulative score and cross-device awareness, the disclosed system may reduce impact of this situation.

As part of dynamic isolation of client device 105 (or associated user), NAC 107 may have the ability to do the following example enforcement actions:
a) send events to force client device 105 to re-authenticate, and after client device 105 re-authenticates, assign client device 105 to a different virtual local area network (VLAN);
b) Send change of role for client device 105 to NAC 107;
c) Apply access control list (ACL) using downloadable roles (an ACL may be dynamically generated on NAC 107 based on network analytics server 108 feedback, and the ACL may be sent to network controller 106 for enforcement). In this example, the ACL may provide attributes to describe how a user currently associated with client device 105 may access the network (e.g., access permissions update);
d) If an associated information technology (IT) help desk system supports an interface for generation of tickets, NAC 107 may automatically raise an IT ticket; and
e) Flag a device for remediation and restore device credentials after remediation is completed.

In one example of functionality that may be associated with different device authentication methods, a user-initiated action may be allowed from a device (e.g., client device 105 in the above example) where a user has supplied two-factor authentication and denied on that same device if that user has only authenticated using simple authentication (e.g., single sign on or single-factor authentication such as a password alone). Thus, the higher degree of authentication may allow additional capabilities across a computer network as opposed to standard authentication. In some implementations, the specific type of authentication provided by a user may be at the discretion of that user upon login to a computer network. As a result, if that user wishes to execute more highly sensitive actions, the user may opt (ahead of time) to login using more secure authentication methods. Otherwise, some actions may not be available to that user based on their current authentication status. In some cases, an action may request additional authentication prior to termination based on an authentication level.

Referring now to FIG. 4, an example flow is illustrated as method 400 representing one example method, that may be implemented on one or more computer systems, to provide integrated network analytics and security enforcement, according to one or more disclosed implementations. Example method 400 begins at block 405 where a device and user authenticate to a network. Network authentication may include a wireless network association as defined in the Institute of Electrical and Electronic Engineers (IEEE) 802.11 standards. Block 410 indicates that a device may additionally be authenticated to a NAC (e.g., NAC 107 of FIG. 1), in part via authentication with a domain server or wireless controller (e.g., wireless access protocol WAP authentication). Block 415 indicates that a user associated with a device may additionally be authenticated using the domain server, remote access dial-up service (RADIUS) server, or another authentication mechanism that may include multi-factor authentication. Block 420 indicates that authentication, for example by NAC 107, may include providing user and device information to a network analytics server.

Block 425 indicates that, at the initiation of the session and throughout the session, a network analytics server (such as network analytics server 108) may collect data from an access control device (e.g., NAC 107) to monitor the session (e.g., login session). Other data source feeds (e.g., as described for FIG. 2) may provide information that is used as part of the monitoring and analysis function. Block 430 indicates that events may be generated (e.g., by networks analytics server 108) based on user alerts and risk scoring of user-initiated actions (e.g., computer commands). Events may be provided to other components as necessary either periodically or based on threshold crossing related to risk scoring. Events may be communicated using various mechanisms including RESTful APIs. Block 435 indicates that a NAC (e.g., NAC 107) may determine actions (e.g., quarantine/isolation actions) such as network disconnection or forced re-authentication. These actions may be enforced with the assistance of other network components including a device controller such as device controller 106 of FIG. 1.

Block 440 indicates that a NAC (e.g., NAC 107) may provide feedback to a network analytics server regarding security actions taken. These actions may be taken immediately or deferred for future application (e.g., if device has disconnected at the time of action determination). Block 445 indicates that a network analytics server (e.g., networks analytics server 108) may maintain a history of actions and event determinations that may be used for further tracking, reporting, or future use (e.g., next time a device or user attempts to authenticate to the network).

FIG. 5 is an example computing device 500, with a hardware processor 501, and accessible machine-readable instructions stored on a machine-readable medium 502 for implementing one example system for integrating network analysis activities with a NAC, according to one or more disclosed example implementations. FIG. 5 illustrates computing device 500 configured to perform the flow of method 400 as an example. However, computing device 500 may also be configured to perform the flow of other methods, techniques, functions, or processes described in this disclosure. In this example of FIG. 5, machine-readable storage medium 502 includes instructions to cause hardware processor 501 to perform blocks 405-445 discussed above with reference to FIG. 4.

A machine-readable storage medium, such as 502 of FIG. 5, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (EPROM), random access memory (RAM), non-volatile random access memory (NVRAM), optical disk, solid state drive (SSD), flash memory chips, and the like. The machine-readable storage medium may be a non-transitory storage medium, where the term “non-transitory” does not encompass transitory propagating signals.

Referring now to FIG. 6, a computer network infrastructure 600 is illustrated. Computer network infrastructure 600 may be used to implement all or part of the disclosed technique for integrated actions between a network analytics server and a NAC, according to one or more disclosed examples. Network infrastructure 600 includes a set of networks where implementations of the present disclosure may operate and be utilized. Network infrastructure 600 comprises a customer network 602, network 608 (e.g., the Internet), cellular network 603, and a cloud service provider network 610. In one example implementation, the customer network 602 may be a local private network, such as local area network (LAN) that includes a variety of network devices that include, but are not limited to switches, servers, and routers. Within customer network 602 there are illustrated a plurality of wireless access points 650 that may each facilitate wireless network connectivity within customer network 602. There may be one or more WLANs supported with in customer network 602 and each of these WLANs may be logically divided into one or more VLANs. Different WLANs within customer network 602 may utilize master controller or master/slave configurations to support wireless clients as described above. Some or all of the WLANs within customer network 602 may be implemented with connections to a NAC and network analytics server as disclosed herein.

Each of these networks may contain wired or wireless programmable devices and operate using any number of network protocols (e.g., TCP/IP) and connection technologies (e.g., WiFi® networks, or Bluetooth®. In another example, customer network 602 represents an enterprise network that could include or be communicatively coupled to one or more local area networks (LANs), virtual networks, data centers (see FIG. 2) and/or other remote networks (e.g., 608, 610). In the context of the present disclosure, customer network 602 may include a network device supporting a NAC such as that described above. Additionally, customer network 602 may represent a target network supported by disclosed implementations of network security based on monitoring of user-initiated actions and analysis of previous user and device network interactions.

As shown in FIG. 6, customer network 602 may be connected to one or more client devices 604A-E and allow the client devices 604A-E to communicate with each other and/or with cloud service provider network 610, via network 608 (e.g., Internet). Client devices 604A-E may be computing systems such as desktop computer 604B, tablet computer 604C, mobile phone 604D, laptop computer (shown as wireless) 604E, and/or other types of computing systems generically shown as client device 604A. Client devices may be authenticated to a network and may be supporting an authenticated session of a user (or users) where each user has authenticated using an authentication technique (e.g., single sign on using a simple password, multi-factor authentication, or even biometric authentication). In any case, client devices 604A-E may be associated with authentication attributes of one or more users.

Network infrastructure 600 may also include other types of devices generally referred to as Internet of Things (IoT) (e.g., edge IoT device 605) that may be configured to send and receive information via a network to access cloud computing services or interact with a remote web browser application (e.g., to receive just-in-time authentication information).

FIG. 6 also illustrates that customer network 602 includes local compute resources 606A-C that may include a server, access point, router, or other device configured to provide for local computational resources and/or facilitate communication amongst networks and devices. For example, local compute resources 606A-C may be one or more physical local hardware devices. Local compute resources 606A-C may also facilitate communication between other external applications, data sources (e.g., 606A and 606B), and services, and customer network 602. In some example implementations, local compute resources may host one or both of the network analytics server or the NAC. Additionally, input data sources to the network analytics server may be provided via one or more of local compute resources 606A-C.

Network infrastructure 600 also includes cellular network 603 for use with mobile communication devices. Mobile cellular networks support mobile phones and many other types of mobile devices such as laptops etc. Mobile devices in network infrastructure 600 are illustrated as mobile phone 604D, laptop computer 604E, and tablet computer 604C. A mobile device such as mobile phone 604D may interact with one or more mobile provider networks as the mobile device moves, typically interacting with a plurality of mobile network towers 620, 630, and 640 for connecting to the cellular network 603.

FIG. 6 illustrates that customer network 602 is coupled to a network 608. Network 608 may include one or more computing networks available today, such as other LANs, wide area networks (WAN), the Internet, and/or other remote networks, in order to transfer data between client devices 604A-D and cloud service provider network 610. Each of the computing networks within network 608 may contain wired and/or wireless programmable devices that operate in the electrical and/or optical domain.

In FIG. 6, cloud service provider network 610 is illustrated as a remote network (e.g., a cloud network) that is able to communicate with client devices 604A-E via customer network 602 and network 608. The cloud service provider network 610 may act as a platform that provides additional computing resources to the client devices 604A-E and/or customer network 602. In one example implementation, cloud service provider network 610 includes one or more data centers 612 with one or more server instances 614. Cloud service provider network 610 may also include one or more frames representing a scalable compute resource that may implement the techniques of this disclosure. Each of the disclosed network security capabilities may be implemented for one or more data centers (not specifically illustrated) that may benefit from disclosed techniques for additional network security and reduction of manual intervention instances.

FIG. 7 illustrates a computing device 700 that may be used to implement the functions, modules, processing platforms, execution platforms, communication devices, and other methods and processes of this disclosure. For example, different functionality (e.g., functional modules of FIG. 2) for a NAC and/or network analytics server may be implemented by different functional modules that may execute directly on physical hardware or be implemented with at least one level of abstraction from the physical processors and utilize virtualization. For example, computing device 700 illustrated in FIG. 7 could represent a client device or a physical server device and include either hardware or virtual processor(s) depending on the level of abstraction of the computing device. In some instances (without abstraction), computing device 700 and its elements, as shown in FIG. 7, each relate to physical hardware. Alternatively, in some instances one, more, or all of the elements could be implemented using emulators or virtual machines as levels of abstraction. In any case, no matter how many levels of abstraction away from the physical hardware, computing device 700 at its lowest level may be implemented on physical hardware.

As also shown in FIG. 7, computing device 700 may include one or more input devices 730, such as a keyboard, mouse, touchpad, or sensor readout (e.g., biometric scanner) and one or more output devices 715, such as displays, speakers for audio, or printers. Some devices may be configured as input/output devices also (e.g., a network interface or touchscreen display). User-initiated actions may be input via these types of user interfaces.

Computing device 700 may also include communications interfaces 725, such as a network communication unit that could include a wired communication component and/or a wireless communications component, which may be communicatively coupled to processor 705. The network communication unit may utilize any of a variety of proprietary or standardized network protocols, such as Ethernet, TCP/IP, to name a few of many protocols, to effect communications between devices. Network communication units may also comprise one or more transceiver(s) that utilize the Ethernet, power line communication (PLC), WiFi, cellular, and/or other communication methods.

As illustrated in FIG. 7, computing device 700 includes a processing element such as processor 705 that contains one or more hardware processors, where each hardware processor may have a single or multiple processor core. In one implementation, the processor 705 may include at least one shared cache that stores data (e.g., computing instructions) that are utilized by one or more other components of processor 705. For example, the shared cache may be a locally cached data stored in a memory for faster access by components of the processing elements that make up processor 705. In one or more implementations, the shared cache may include one or more mid-level caches, such as level 2 (L2), level 3 (L3), level 4 (L4), or other levels of cache, a last level cache (LLC), or combinations thereof. Examples of processors include but are not limited to a central processing unit (CPU) a microprocessor. Although not illustrated in FIG. 7, the processing elements that make up processor 705 may also include one or more of other types of hardware processing components, such as graphics processing units (GPU), application specific integrated circuits (ASICs), field-programmable gate arrays (FPGAs), and/or digital signal processors (DSPs).

FIG. 7 illustrates that memory 710 may be operatively and communicatively coupled to processor 705. Memory 710 may be a non-transitory medium configured to store various types of data. For example, memory 710 may include one or more storage devices 720 that comprise a non-volatile storage device and/or volatile memory. Volatile memory, such as random-access memory (RAM), can be any suitable non-permanent storage device. The non-volatile storage devices 720 can include one or more disk drives, optical drives, solid-state drives (SSDs), tap drives, flash memory, read only memory (ROM), and/or any other type of memory designed to maintain data for a duration of time after a power loss or shut down operation. In certain instances, the non-volatile storage devices 720 may be used to store overflow data if allocated RAM is not large enough to hold all working data. The non-volatile storage devices 720 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 705. In one implementation, the compiling process of the software program may transform program code written in a programming language to another computer language such that the processor 705 is able to execute the programming code. For example, the compiling process of the software program may generate an executable program that provides encoded instructions (e.g., machine code instructions) for processor 705 to accomplish specific, non-generic, particular computing functions.

After the compiling process, the encoded instructions may then be loaded as computer executable instructions or process steps to processor 705 from storage device 720, from memory 710, and/or embedded within processor 705 (e.g., via a cache or on-board ROM). Processor 705 may be configured to execute the stored instructions or process steps in order to perform instructions or process steps to transform the computing device into a non-generic, particular, specially programmed machine or apparatus. Stored data, e.g., data stored by a storage device 720, may be accessed by processor 705 during the execution of computer executable instructions or process steps to instruct one or more components within the computing device 700.

A user interface (e.g., output devices 715 and input devices 730) can include a display, positional input device (such as a mouse, touchpad, touchscreen, or the like), keyboard, or other forms of user input and output devices. The user interface components may be communicatively coupled to processor 705. When the output device is or includes a display, the display can be implemented in various ways, including by a liquid crystal display (LCD) or a cathode-ray tube (CRT) or light emitting diode (LED) display, such as an organic light emitting diode (OLED) display. Persons of ordinary skill in the art are aware that the computing device 700 may comprise other components well known in the art, such as sensors, powers sources, and/or analog-to-digital converters, not explicitly shown in FIG. 7.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A computer-implemented method comprising:
receiving authentication information from a network controller at a network access control (NAC) device, the authentication information associated with a client device and a user attempting to gain access to a computer network for a login session;
providing information regarding attributes of the user and the client device to a network analytics server executing a network analytics engine (NAE), the NAE providing analysis functions and risk level rankings for one or more user-initiated actions within the computer network;
receiving information at the NAC device pertaining to monitoring of the one or more user-initiated actions by the NAE; and
providing information regarding security actions from the NAC device to the network controller based on a risk determination associated with each of the one or more user-initiated actions.

2. The computer-implemented method of claim 1, wherein receiving information at the NAC device includes receiving an NAE event generated by the NAE, the NAE event indicating a potential security breach associated with a first user-initiated action of the one or more user-initiated actions.

3. The computer-implemented method of claim 2, wherein the NAE event provides an indication to quarantine the client device.

4. The computer-implemented method of claim 3, wherein the NAE event providing the indication to quarantine the client device is further compared to an action threshold at the NAC device to determine whether to initiate the quarantine, the quarantine being initiated responsive to crossing the action threshold and deferred responsive to not crossing the action threshold.

5. The computer-implemented method of claim 3, further comprising:
sending a NAC event from the NAC device to the network controller to isolate the client device with respect to further communications on the computer network.

6. The computer-implemented method of claim 2, further comprising:
sending a NAC event from the NAC device to the network controller to terminate an authenticated session; and
force re-authentication of the client device and the user prior to allowing further communications on the computer network.

7. The computer-implemented method of claim 1, wherein the monitoring of the one or more user-initiated actions by the NAE includes using information obtained from an external data source containing information about the user.

8. The computer-implemented method of claim 7, wherein the external data source is selected from the group consisting of active directory, domain name service, tap to switch, employee information, security information and event management, firewall rules, corporate records, historical ranking information, and device parameters.

9. The computer-implemented method of claim 1, wherein the monitoring of the one or more user-initiated actions by the NAE includes using information obtained from a previous login session for the user or the client device to perform the risk determination associated with each of the one or more user-initiated actions.

10. The computer-implemented method of claim 1, wherein the monitoring of the one or more user-initiated actions by the NAE includes reducing a risk value for each risk determination associated with each of the one or more user-initiated actions based on a type of user authentication for the login session, a multi-factor user authentication causing a greater reduction of risk value than a single factor authentication, and a biometric user authentication causing a greater reduction of risk value than a password authentication.

11. The computer-implemented method of claim 1, wherein the monitoring of the one or more user-initiated actions by the NAE includes using machine learning and deep data analysis.

12. A computer device comprising:
a processing device communicatively coupled to a network interface; and
a memory storing instructions, that when executed by the processing device, cause the computer device to:
receive authentication information from a network controller, the authentication information associated with a client device and a user attempting to gain access to a computer network for a login session;
provide information regarding attributes of the user and the client device to a network analytics server executing a network analytics engine (NAE), the NAE providing analysis functions and risk level rankings for one or more user-initiated actions within the computer network;
receive information pertaining to monitoring of the one or more user-initiated actions by the NAE; and
provide information regarding security actions to the network controller based on a risk determination associated with each of the one or more user-initiated actions.

13. The computer device of claim 12, wherein the instructions to cause the computer device to receive information include instructions to cause the computer device to receive an event generated by the NAE, the event indicating a potential security breach associated with a first user-initiated action of the one or more user-initiated actions.

14. The computer device of claim 13, wherein the instructions to cause the computer device to provide information regarding security actions to the network controller include instructions to:
compare a risk factor associated with the potential security breach to a cumulative risk value associated with the login session;
determine if the cumulative risk value associated with the login session has crossed an action threshold;
based on a determination that the action threshold has been crossed, send an event to the network controller to isolate the client device with respect to further communications on the computer network; and
based on a determination that the action threshold has not been crossed, increase the cumulative risk value associated with the login session.

15. The computer device of claim 14, wherein the instructions to cause the computer device to provide information regarding security actions to the network controller include instructions to:
determine if the user associated with the client device and the login session is further associated with a different login session on a different end-user device; and
send a NAC event to the network controller to isolate the different end-user device in addition to sending the event to isolate the client device.

16. A non-transitory computer readable medium comprising computer executable instructions that, when executed by one or more processing units, cause the one or more processing units to:
receive authentication information from a network controller at a network access control (NAC) device, the authentication information associated with a client device and a user attempting to gain access to a computer network for a login session;
provide information regarding attributes of the user and the client device to a network analytics server executing a network analytics engine (NAE), the NAE providing analysis functions and risk level rankings for one or more user-initiated actions within the computer network;
receive information at the NAC device pertaining to monitoring of the one or more user-initiated actions by the NAE; and
provide information regarding security actions from the NAC device to the network controller based on a risk determination associated with each of the one or more user-initiated actions.

19. The non-transitory computer readable medium of claim 18, further comprising computer executable instructions that, when executed by one or more processing units, cause the one or more processing units to:
compare a risk factor associated with the potential security breach to a cumulative risk value associated with the login session;
determine if the cumulative risk value associated with the login session has crossed an action threshold;
based on a determination that the action threshold has been crossed, send a first NAC event from the NAC device to the network controller to isolate the client device with respect to further communications on the computer network; and
based on a determination that the action threshold has not been crossed, increase the cumulative risk value associated with the login session.

20. The non-transitory computer readable medium of claim 19, further comprising computer executable instructions that, when executed by one or more processing units, cause the one or more processing units to:
determine if the user associated with the client device and the login session is further associated with a different login session on a different end-user device; and
send a second NAC event from the NAC device to the network controller to isolate the different end-user device in addition to sending the event to isolate the client device.
